(19) United States
(12) Patent Application Publication
(10) Pub. No.: US 2006/0288671 A1
(43) Pub. Date: Dec. 28, 2006

(54) Cyclone dust collecting apparatus for wet vacuum cleaner

(75) Inventors: Jang-keun Oh, Gwangju-city (KR); Soon-tack Lim, Kyungsangnam-do (KR); Jung-gyun Han, Busan (KR)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/317,572

(22) Filed: Dec. 23, 2005

(30) Foreign Application Priority Data
Jun. 22, 2005 (KR) 10-2005-0054073

(51) Int. Cl. B01D 50/00

(52) U.S. Cl. 55/333

(57) ABSTRACT

A cyclone dust collecting apparatus for a wet vacuum cleaner having a cyclone body separating air from drawn in contaminants and water, a contaminant receptacle formed at a bottom portion of the cyclone body to collect contaminants and water separated by the cyclone body, and a water tank integrally formed with the contaminant receptacle to store clean water.

### CROSS-REFERENCE TO RELATED APPLICATIONS

This application claims the benefit of Korean Patent Application No. 2005-54073 filed on Jun. 22, 2005, in the Korean Intellectual Property Office, the disclosure of which is incorporated herein by reference in its entirety.

### BACKGROUND OF THE INVENTION

1. Field of the Invention

The present invention relates to a vacuum cleaner with a wet cleaning function. More particularly, the present invention relates to a cyclone dust collecting apparatus for a wet vacuum cleaner.

2. Description of the Related Art

Generally, a wet vacuum cleaner sprays water onto hard cleaning surfaces such as linoleum, hardwood floors, tile, and marble, wipes off stains from the cleaning surfaces with a brush, and draws in the contaminants with water. Generally, wet vacuum cleaners separate contaminants and water from the water-laden air in order to discharge air to the outside and collect the separated contaminants and water.

U.S. Pat. No. 6,647,578 filed on Sept. 18, 2001 discloses a conventional wet vacuum cleaner. The wet vacuum cleaner guides contaminants and water-laden air to collide with a separation wall, which separates the contaminants and water from the air, collects the separated contaminants and water into a contaminant receptacle at a lower portion of the separation wall, and discharges the air to the outside via a filter of an upper portion of the separation wall. Additionally, the wet vacuum cleaner has a float in the contaminant receptacle to prevent the collected water from flowing out of the contaminant receptacle.

When the water reaches a certain level in the contaminant receptacle, the float blocks an air discharge pipe, preventing the cleaner from functioning.

However, the conventional wet vacuum cleaner requires an individual dedicated water tank for supplying water and a contaminant receptacle for collecting drawn in water and contaminants, both of which require large spaces. Therefore, it is difficult to miniaturize a wet vacuum cleaner.

The conventional wet vacuum cleaner separates water and contaminants from air by the collision of drawn in air so that the water may be foggy and a part of the foggy water may be directly drawn into a vacuum generator.

The conventional wet vacuum cleaner separates contaminants from air by the collision of drawn in air so that dry dust may not be separated from the air but drawn into the filter along with the air. Therefore, the filter may be easily contaminated. Accordingly, the cleaning cycle of the filter is very short. The pre-collected water is moved up and down by the suction air so as to splash.

During operation, the prior art wet vacuum cleaner inclines so that the float in the contaminant receptacle, which relies on the buoyancy of water, may not operate properly. Accordingly, the water collected in the contaminant receptacle may flow backward into the vacuum generator or flow out of an inlet.

Additionally, the contaminant receptacle must be separated to empty the full contaminant receptacle, and the water tank must be separated to fill up the empty water tank. In other words, the contaminant receptacle and the water tank are separately formed, and there is no relation between when the contaminant receptacle is filled and when the water of water tank is all consumed. Therefore, in the prior art, the contaminant receptacle and the water tank are separately managed. Accordingly, it is inconvenient for a user to keep the wet vacuum cleaner in working condition.

### SUMMARY OF THE INVENTION

The present invention has been conceived to solve the above-mentioned problems occurring in the prior art, and an aspect of the present invention is to provide a cyclone dust collecting apparatus for a wet vacuum cleaner with an integrated contaminant receptacle and water tank so that removal of contaminants and supply of water can be simultaneously performed.

Another aspect of the present invention is to provide a cyclone dust collecting apparatus for a wet vacuum cleaner which can prevent a part of drawn in water from directly flowing into a vacuum generator.

Yet another aspect of the present invention is to provide a cyclone dust collecting apparatus for a wet vacuum cleaner which allows for the miniaturization of a vacuum cleaner.

In order to achieve the above aspects, there is provided a cyclone dust collecting apparatus for a wet vacuum cleaner, comprising a cyclone body separating air from drawn in contaminant and water, a contaminant receptacle formed at a bottom portion of the cyclone body to collect contaminant and water separated by the cyclone body, and a water tank integrally formed with the contaminant receptacle to store clean water.

The capacity of contaminants and water collected in the contaminant receptacle may be greater than the capacity of water stored in the water tank.

The water tank may be formed at a bottom portion of the contaminant receptacle. A cavity may protrude from the bottom surface of the contaminant receptacle, and be fluidly communicated with the water tank.

The water tank may comprise a water tank cover attached to the bottom surface of the contaminant receptacle by ultrasonic welding, and a water supply valve attached to the water tank cover to selectively discharge water stored between the water tank cover and the bottom surface of the contaminant receptacle.

The cyclone dust collecting apparatus may further comprise a contaminant cover which is attached into a top portion of the contaminant receptacle by ultrasonic-welding and which includes a contaminant opening to allow the contaminants and water separated by the cyclone body to fall into the contaminant receptacle.

The contaminant opening may be positioned along the bottom surface of the contaminant cover in a band form, having a length such that an angle between opposite ends of the contaminant opening and the center of the contaminant cover is approximately 160-180 degrees and the width of the contaminant opening is approximately 6-8 mm.

The contaminant cover may further comprise a plurality of protrusions formed on the bottom surface.

The cyclone dust collecting apparatus may further comprise a contaminant discharge path formed at one side of the contaminant receptacle to discharge the contaminants and water from the contaminant receptacle.

In order to achieve the above aspects, there is provided a cyclone dust collecting apparatus for a wet vacuum cleaner, comprising a cyclone body separating air from drawn in contaminants and water and including an air discharge opening for discharging the separated air, a water block member enclosing the air discharge opening to block a discharge of the drawn in water with air and including a cut part at a bottom portion, and a contaminant receptacle formed at a bottom portion of the cyclone body to collect contaminants and water separated by the cyclone body.

The cut part may be cut to have such a length that an angle between opposite ends of the cut part and the center of the water block member is approximately 80 to 90 degrees.

The water block member may further comprise an inner curtain formed in a bottom end and in parallel with the cyclone body.

The cyclone dust collecting apparatus may further comprise a water tank integrally formed with the contaminant receptacle to store clean water.

The capacity of contaminants and water that can be collected in the contaminant receptacle is greater than the capacity of water that can be stored in the water tank.

The cyclone dust collecting apparatus for the wet vacuum cleaner according to embodiments of the present invention has the integral contaminant receptacle and water tank, and therefore, the contaminant receptacle and the water tank can be separated at once to supply water together with the discharge of contaminant. Accordingly, with the present invention, it is more convenient for a user to keep the vacuum cleaner in working condition when compared to the prior art.

Since the contaminant receptacle and the water tank are integrally formed, the vacuum cleaner can be miniaturized.

Since a storable capacity of water in the water tank is less than a collectable capacity of contaminant in the contaminant receptacle, the contaminant receptacle can be separated to be emptied of the collected contaminant and water before the contaminant receptacle is full. Accordingly, a dedicated device is not required to detect the amount of water collected in the contaminant receptacle, as in the prior art.

In the cyclone dust collecting apparatus for the wet vacuum cleaner according to embodiments of the present invention, water collected in the contaminant receptacle does not flow backward; the contaminant cover prevents the water from flowing backward, even when the cleaner body is inclined.

In the cyclone dust collecting apparatus for the wet vacuum cleaner according to embodiments of the present invention, the collected water also does not move up and down or splash as a result of the rotative stream, since the contaminant cover is formed between the cyclone body and the contaminant receptacle.

The cyclone dust collecting apparatus for the wet vacuum cleaner according to embodiments of the present invention can efficiently separate air from water and contaminants or air from contaminants only.

Additionally, since the cyclone dust collecting apparatus for the wet vacuum cleaner according to embodiments of the present invention draws in contaminants and water by a cyclone scheme, suction efficiency can be maintained for a long period even when contaminants are accumulated in the contaminant receptacle.

### BRIEF DESCRIPTION OF THE DRAWINGS

The above and other aspects, features and advantages of the present invention will be more apparent from the following detailed description taken with reference to the accompanying drawings, in which:

FIG. 1 is a perspective view of a cyclone dust collecting apparatus for a wet vacuum cleaner according to an embodiment of the present invention;

FIG. 2 is a cut-out, perspective view of the cyclone dust collecting apparatus for the wet vacuum cleaner of FIG. 1;

FIG. 3 is a sectional view of the cyclone dust collecting apparatus for the wet vacuum cleaner of FIG. 1;

FIG. 4 is a perspective view of a contaminant receptacle of the cyclone dust collecting apparatus for the wet vacuum cleaner of FIG. 1;

FIG. 5 is a perspective view of an alternate exemplary embodiment of the water block member of the cyclone dust collecting apparatus for the vacuum cleaner of FIG. 1;

FIG. 6 is a sectional view of a cover of water tank of the cyclone dust collecting apparatus for the wet vacuum cleaner with the wet cleaning of FIG. 1;

FIG. 7 is a view for illustrating that water collected in the contaminant receptacle does not flow backward as the cyclone dust collecting apparatus for the wet vacuum cleaner of FIG. 1 inclines; and

FIG. 8 is a side view of a wet vacuum cleaner employing the cyclone dust collecting apparatus for the wet vacuum cleaner of FIG. 1.

### DETAILED DESCRIPTION OF THE INVENTION

Exemplary embodiments of the present invention will be described in detail with reference to the annexed drawings. In the drawings, the same elements are denoted by the same reference numerals throughout. In the following description, detailed descriptions of known functions and configurations incorporated herein have been omitted for conciseness and clarity.

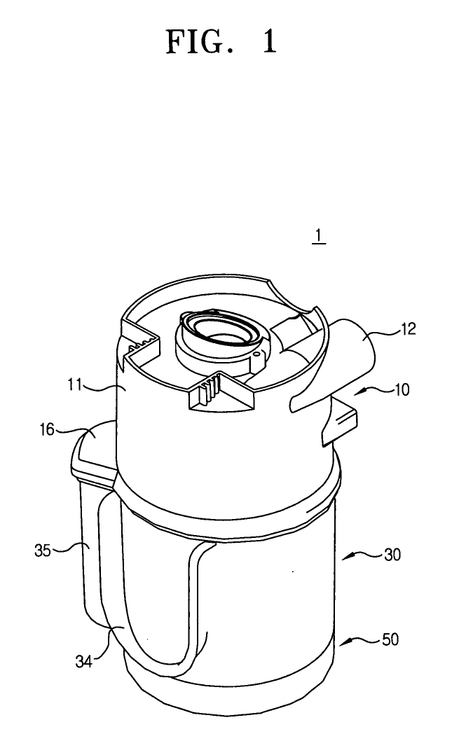

Referring to FIGS. 1 through 3, a cyclone dust collecting apparatus for a wet vacuum cleaner 1 according to an embodiment of the present invention comprises a cyclone body 10, a contaminant receptacle 30, and a water tank 50.

The cyclone body 10 separates contaminants and water from air to discharge cleaned air to a vacuum generator, and comprises a body housing 11, a grille 13, and a water block member 20.

The body housing 11 is cylindrical and has an opened bottom portion and an air discharge opening 17 for discharging cleaned air at an upper portion. The body housing 11 has at one side a contaminant inlet 12 for flowing contaminant and water-laden air (hereinafter, contaminant-laden air) therein. The contaminant inlet 12 is formed in a tangential direction to the body housing 11 for contaminant-laden air drawn in via a contaminant suction opening (not shown) to form a rotative stream.

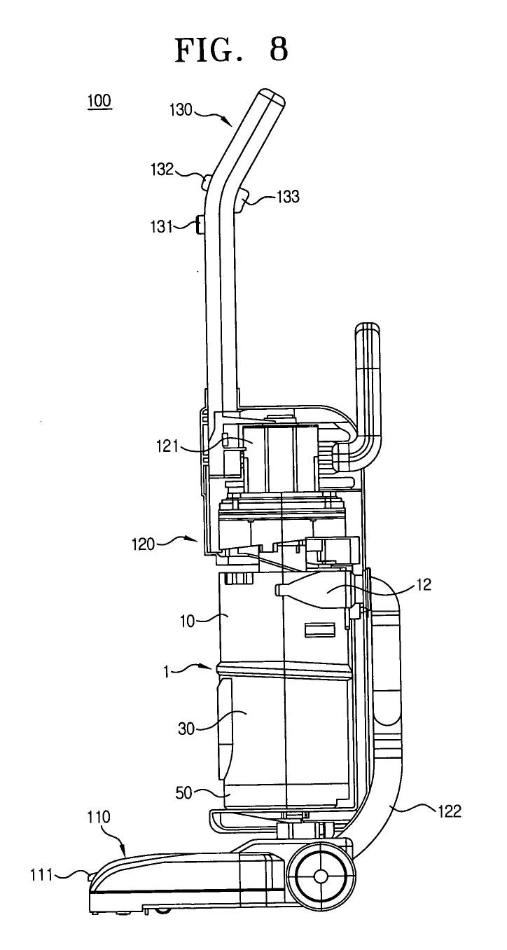

The grille 13 is formed in the air discharge opening 17 of a upper center of the body housing 11 and discharges cleaned air separated from contaminant and water to a vacuum generator 121 (refer to FIG. 8). The grille 13 is hollow and cylindrical, of which top end 13a is connected with the air discharge opening 17 of the upper portion of the body housing 11 to fluidly communicate with the vacuum generator 121, and of which bottom end is closed and has a skirt 15 for blocking contaminants that flow backward. A suction opening 14 for passing air is formed on a surface of the grille 13. According to one preferred embodiment of the present invention, the suction opening 14 is provided with a plurality of slots. In an alternate embodiment, the suction opening 14 may be provided with a plurality of holes.

The water block member 20 prevents water drawn with air into the contaminant inlet 12 from directly discharging via the air discharge opening 17 to the vacuum generator 121 and is configured to guide the drawn in water to the body housing 11.

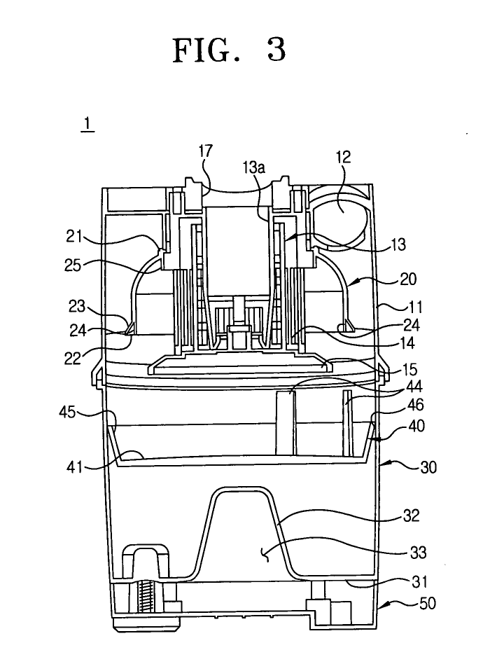

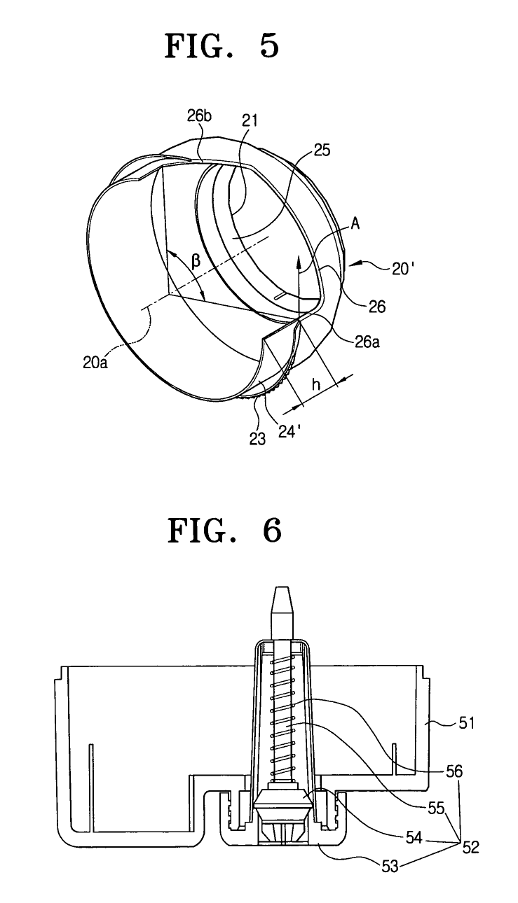

According to an embodiment of the present invention, the water block member 20 is formed on the outside of the grille 13 to enclose the suction opening 14 so as to prevent water from directly discharging via the suction opening 14 of the grille 13 to the vacuum generator 121. If the grille 13 is installed without the water block member 20, some of water flowing in via the contaminant inlet 12 is directly drawn into the suction opening 14 of the grille 13 due to inertial force and surface tension of water. Referring to FIG. 3, the diameter of the water block member 20 increases from a top end 21 to a bottom end 22. In other words, the diameter of the bottom end 22 is greater than that of the top end 21, and the intermediate portion between the bottom end 22 and the top end 21 is connected in a smooth curve. The water block member 20 has a slant part 23, which is steep, at the bottom end 22 to move water toward the body housing 11 as the water flows along the outside surface of the water block member 20. The water block member 20 has a cut part 26 at the bottom end 22. FIG. 5 shows an alternate exemplary embodiment of the water block member 20′. Referring to FIG. 5, the cut part 26 discharges water in a substantially tangential direction to the water block member 20′ (illustrated by arrow A in FIG. 5) due to the inertia force exerted on the water, as water flows from the bottom end 22 into the inside of the water block member 20′. Preferably, the cut part 26 is cut to have such a length that angle β between the cut part 26 and a center 20a of the water block member 20′ is approximately 80 to 90 degrees. Opposite ends 26a, 26b of the cut part 26 may be cut so as to be substantially perpendicular to the bottom end 22. However, preferably, according to the rotation direction of the air, one end 26a of cut part 26 discharging water may be substantially perpendicular to the bottom end 22 and the other end 26b may be positioned at an angle with respect to the bottom end 22. An inner curtain 24 is formed in the bottom end 22 of the water block member 20, in parallel with the body housing 11. The inner curtain 24 has a cut portion to correspond to the cut part 26. The inner curtain 24 maintains regular dust collection efficiencies for a plurality of cyclone dust collecting apparatuses, as the speeds of airflow drawn in the plurality of cyclone dust collecting apparatuses are varied. In other words, the length of the inner curtain 24 is adjusted according to the speed of airflow drawn in the plurality of cyclone dust collecting apparatuses so that the dust collection efficiencies of the plurality of cyclone dust collecting apparatuses can be regularly controlled. For example, if the speed of airflow is fast in a cyclone dust collecting apparatus, the length of the inner curtain 24 shortens as shown in FIG. 3, and if the speed of airflow is slow in a cyclone dust collecting apparatus, the length h of the inner curtain 24′ lengthens, as shown in FIG. 5, so that the dust collection efficiencies of the plurality of cyclone dust collecting apparatuses can be regularly controlled irrespective of the speed of airflow. Additionally, a top inner curtain 25 may be provided in the top end 21 of the water block member 20′.

The contaminant receptacle 30 is formed at a lower portion of the cyclone body 10, and collects contaminants and water separated by the cyclone body 10. The contaminant receptacle 30 is cylindrical, and has an opened top portion and a cavity 32 protruding from a receptacle bottom surface 31. The cavity 32 has an inside 33 fluidly communicated with the water tank 50 to store water for a wet cleaning. The cavity 32 reduces the volume of the contaminant receptacle 30 and increases the volume of the water tank 50.

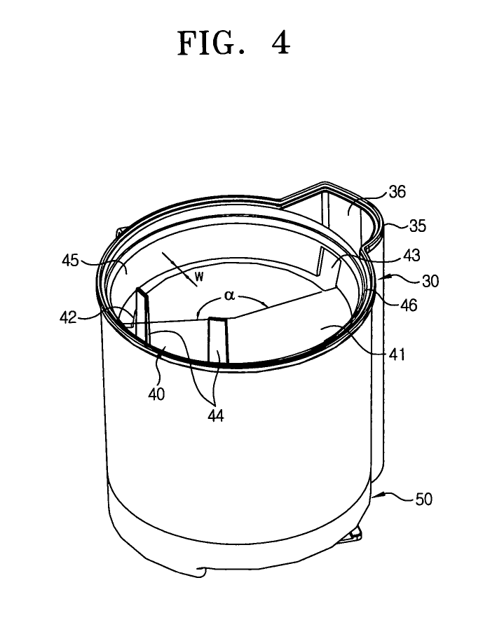

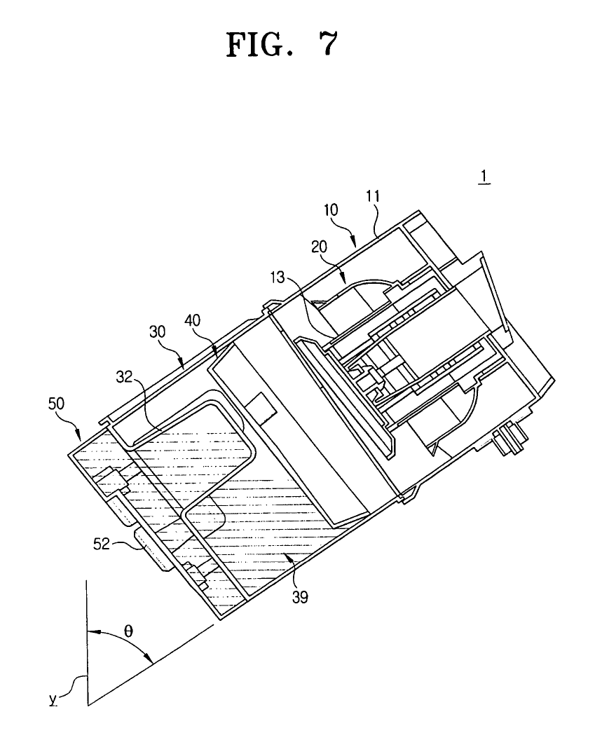

A contaminant cover 40 is formed at a top portion in the contaminant receptacle 30. The contaminant cover 40 prevents the water and contaminants collected in the contaminant receptacle 30 from flowing backward to the cyclone body 10, and also prevents water collected in the contaminant receptacle 30 from moving up and down or splashing due to the rotative stream of contaminant-laden air formed in the cyclone body 10. A contaminant opening 42 (refer to FIG. 4) is formed on a bottom surface 41 of the contaminant cover 40, allowing contaminants and water to fall into the contaminant receptacle 30 as they are separated from air in the cyclone body 10. The contaminant cover 40 is formed in the contaminant receptacle 30 and the contaminant opening 42 faces the front of the cleaner body 120 so that water does not flow backward via the contaminant opening 42 even when the cleaner body 120 (refer to FIG. 8) inclines by an angle θ, as much as approximately 60 to 65 degrees from a vertical axis y (refer to FIG. 7). Referring to FIG. 4, the contaminant opening 42 is provided near a portion of the outer circumference of the bottom surface 41 of the contaminant cover 40, in a band form. Preferably, the contaminant opening 42 is formed to have such a length that the angle α between the center of the contaminant cover 40 and the opposite ends of the contaminant opening 42 is approximately 160 to 180 degrees, with a width W of approximately 6 to 8 millimeters (mm). The contaminant cover 40 further comprises a plurality of protrusions 44 for catching thin and long contaminants such as paper, hair, and thread. To increase the efficiency for catching the thin and long contaminants, contaminant cover 40 preferably contains two protrusions 44. However, the present invention may contain any number of protrusions 44. The contaminant cover 40 is integrally attached to the contaminant receptacle 30 to prevent water from flowing out of a connection part 46. The contaminant cover 40 may be attached to the contaminant receptacle 30 by ultrasonic-welding for waterproofing. Accordingly, the contaminant cover 40 can not be separated from the contaminant receptacle 30. If a frame 45 is formed on the outer circumference of the contaminant cover 40 as shown in FIG. 4 for convenience of waterproofing and attaching, a discharge hole 43 may be formed on the frame 45 to easily discharge contaminants and water.

The contaminant receptacle 40 further comprises at one side a contaminant discharge path 35 to discharge the contaminants and water collected in the contaminant receptacle 30. Since the contaminant discharge path 35 is opened to the contaminant receptacle 30, the contaminants and water collected in the contaminant receptacle 30 are discharged via the contaminant discharge path 35 to the outside as an entrance 36 of the contaminant discharge path 35 inclines downward. As the contaminant receptacle 30 is attached to the bottom portion of the cyclone body 10, the entrance 36 of the contaminant discharge path 35 is hermetically sealed by a contaminant discharge path cover 16 at one side of the cyclone body 10 (refer to FIG. 1).

The water tank 50 is integrally formed with the contaminant receptacle 30 and stores a certain amount of clean water. The amount of stored water in the water tank 50 may be less than the maximum collectable amount of contaminants and water of the contaminant receptacle 30. Therefore, water of the water tank 50 may be completely consumed before the contaminant receptacle 30 is filled with contaminant and water so that the contaminant receptacle 30 can be emptied of the contaminant and water when supplying the water tank 50 with water. Accordingly, a dedicated apparatus such as a float is not necessary for detecting the amount of water collected in the contaminant receptacle 30.

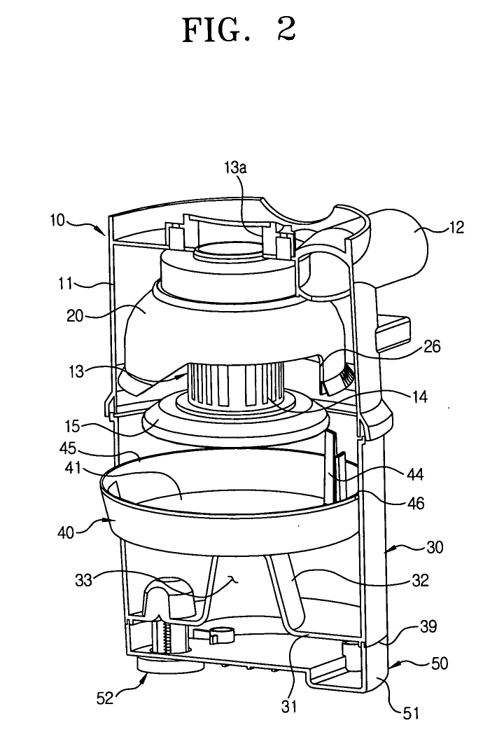

Referring to FIGS. 2 and 3, the water tank 50 is formed below the bottom surface 31 of the contaminant receptacle 30. The water tank 50 comprises the bottom surface 31 of the contaminant receptacle 30 and a water tank cover 51 integrally attached to the bottom surface 31 of the contaminant receptacle 30. If the cavity 32 is formed at the bottom surface 31 of the contaminant receptacle 30, water is also stored in the inside 33 of the cavity 32. The water tank cover 51 may be attached to the bottom surface 31 of the contaminant receptacle 30 by ultrasonic-welding, preventing water from flowing into a space 39 between the water tank cover 51 and the bottom surface 31 of the contaminant receptacle 30. The water tank cover 51 comprises a water supply valve 52 to selectively discharge water of the water tank 50. Referring to FIG. 6, the water supply valve 52 comprises a valve cap 53 fixed to the water tank cover 51, a valve seal 54 for opening and closing an entrance of the valve cap 53, a valve shaft 55 fixed to the valve seal 54, and a valve spring 56 having the valve shaft 55 therein for the valve seal 54 to block the entrance of the valve cap 53. Accordingly, as the water tank 50 is mounted to the cleaner body 120, the valve seal 54 is opened to discharge water of the water tank 50. The water is discharged to the outside via a water supply hose (not shown) at a lower portion of the water supply valve 52. As the water tank 50 is separated from the cleaner body 120, the valve spring 56 allows the valve seal 54 to close the valve cap 53 so as to block the discharge of water of the water tank 50.

The operation of the cyclone dust collecting apparatus 1 for the wet vacuum cleaner having the above structure according to an embodiment of the present invention will be described in detail below with reference to FIGS. 1 through 5.

As contaminant-laden air flows into the contaminant inlet 12, the contaminant-laden air forms a rotative stream in the body housing 11. Then, contaminants and water are separated from the air due to the centrifugal force of the rotative stream. The separated contaminants and water fall to the contaminant cover 40 due to gravity. The contaminant and water fallen to the contaminant cover 40 are rotated by the rotative stream and then fall into the contaminant receptacle 30 via the contaminant opening 42 to be collected therein.

During this process, some of the water in the contaminant-laden air is attached to the outer surface of the water block member 20 due to the inertia force and the surface tension. The water attached to the outer surface of the water block member 20 flows down along the surface. Upon reaching the bottom portion of the water block member 20, part of the water flows toward the body housing 11 via the slant part 23. Part of the water that reaches the bottom end 22 of the slant part 23 flows into the inside of the water block member 20 due to the inertia force and the surface tension. The water that flows into the inside of the water block member 20 rotates along the inner surface of the water block member 20 due to the inertia force and is discharged via the cut part 26 in a tangential direction (illustrated by arrow A of FIG. 5) to the water block member 20. Accordingly, water in the contaminant-laden air is never directly discharged via the grille 13.

The vacuum cleaner having the cyclone dust collecting apparatus 1 for the wet vacuum cleaner with the above structure will be described below.

Referring to FIG. 8, the vacuum cleaner 100 comprises a brush assembly 110, the cleaner body 120, and a handle 130.

The brush assembly 110 comprises a contaminant suction opening (not shown) for drawing in contaminant and water in contact with the cleaning surface, a water exhaust nozzle 111 for exhausting water, and a brush (not shown) for wiping off the cleaning surface.

The cleaner body 120 comprises the cyclone dust collecting apparatus 1 for the wet cleaner, and the vacuum generator 121.

The cyclone dust collecting apparatus 1 comprises the cyclone body 10 separating contaminants and water from the contaminant-laden air to discharge only cleaned air, the contaminant receptacle 30 collecting the contaminant and water separated by the cyclone body 10, and the water tank 50 storing water to supply the water exhaust nozzle 111 of the brush assembly 110 with water. The cyclone dust collecting apparatus 1 has the same structure as those of the above embodiment, and therefore, the detailed description thereof will be omitted. The contaminant inlet 12 of the cyclone body 10 and the contaminant suction opening of the brush assembly 110 are fluidly communicated via a suction hose 122.

The vacuum generator 121 generates a suction force for the brush assembly 110 to draw in contaminants and water, and is formed on a top portion of the cyclone dust collecting apparatus 1. For the vacuum generator 121, an impeller (not shown) and a motor assembly (not shown) including a motor (not shown) are generally used.

The handle 130 is formed at a upper portion of the cleaner body 120, and comprises a cleaning mode selection switch 132 for selecting between general cleaning and wet cleaning, a power switch 131 for turning on and off the motor (not shown) of the vacuum generator 121, and a water exhaust switch 133 for turning on and off water exhaust from the water exhaust nozzle 111.

Operation of the vacuum cleaner 100 with the above-described structure will be explained with reference to FIGS. 1 through 8.

Grasping the handle 130, a user inclines the cleaner body 120 by a certain degree from the perpendicular, and then turns on the power switch 131 to move the brush assembly 110 and perform the cleaning. During wet cleaning, as the water exhaust nozzle switch 133 is pressed, water is exhausted from the water exhaust nozzle 111 of the brush assembly 110 to a front side of the brush assembly 110. In other words, water of the water tank 50 of the cleaner body 120 is supplied to the water exhaust nozzle 111 via the water supply hose (not shown) in the brush assembly 110. The water exhaust switch 133 turns on and off the water exhaust valve (not shown) between the water tank 50 and the water exhaust nozzle 111 to control water exhaust.

As the brush assembly 110 moves forward, the brush of the brush assembly 110 rubs the wet cleaning surface to remove stains from the cleaning surface. The contaminant and water removed from the cleaning surface are drawn into the contaminant suction opening and flow into the contaminant inlet 12 of the cyclone dust collecting apparatus 1 via the suction hose 122. The contaminant and water flowed in the cyclone dust collecting apparatus 1 are separated from air by the centrifugal force and collected into the contaminant receptacle 30.

In the vacuum cleaner 100 employing the cyclone dust collecting apparatus 1 according to an embodiment of the present invention, the contaminant and water collected in the contaminant receptacle 30 do not flow backward, even when the cleaner body 120 inclines. This operation will be explained in detail. While the vacuum cleaner 100 is in use, the cleaner body 120 may be inclined by as much as approximately 60 to 65 degrees from the upright position, (in other words, when the cleaner body 120 is perpendicular to the cleaning surface). When the cleaner body 120 inclines, the cyclone dust collecting apparatus 1 in the cleaner body 120 inclines by the same angle θ. As shown in FIG. 7, in the cyclone dust collecting apparatus 1 according to an embodiment of the present invention, the contaminant cover 40 on a top portion of the contaminant receptacle 30 prevents contaminants and water 39 collected in the contaminant receptacle 30 from flowing backward to the cyclone body 10 even when the cyclone dust collecting apparatus 1 is inclined and the contaminant receptacle 30 is filled with contaminants and water 39.

The air removed of contaminants and water in the cyclone dust collecting apparatus 1 is discharged via the grille 13 to the vacuum generator 121. The air flowing in the vacuum generator 121 is discharged via the discharge opening (not shown) in the cleaner body 120 to the outside of the cleaner body 120 of the vacuum cleaner 100.

As wet cleaning continues, the water level in water tank 50 is reduced as water is consumed, while contaminants and water accumulate in the contaminant receptacle 30. The cyclone dust collecting apparatus 1 for a wet vacuum cleaner according to an embodiment of the present invention has less storable capacity of water in the water tank 50 than maximum collectable capacity of contaminants and water in the contaminant receptacle 30 so that the water of the water tank 50 is all consumed before the contaminant receptacle 30 is filled with contaminants and water. When the water tank 50 is empty, the water tank 50 can be separated from the cleaner body 120 to supply water to the water tank 50. Because the water tank 50 and the contaminant receptacle 30 are integrally formed, the water tank 50 and the contaminant receptacle 30 are separated from vacuum cleaner 100 together. To fill the separated water tank 50 with water, the contaminant receptacle 30 should be turned downward. Accordingly, it is necessary to discharge all the contaminant and water from the contaminant receptacle 30 prior to filling the water tank 50 with water. The entrance 36 of the contaminant discharge path 35 inclines downward to discharge the contaminant and water from the contaminant receptacle 30. Then, the contaminant receptacle 30 is reversed to lay the water tank 50 upward, and the water tank 50 is filled with water. Once the water tank 50 has been filled with water, the contaminant receptacle 30 and the water tank 50 are mounted in the cleaner body 120, and the water supply valve 52 is opened to supply water of the water tank 50. A user may now turn on and off the water exhaust switch 133 to continue the wet-cleaning.

According to an embodiment of the present invention, to supply the water tank 50 with water, the contaminant receptacle 30, and the integrally formed water tank 50 are separated from vacuum cleaner 100, and contaminants and water collected in the contaminant receptacle 30 are first discharged so that contaminants and water in the contaminant receptacle 30 do not flow backward. Accordingly, it is not necessary to install a float to detect the amount of water collected in the contaminant receptacle 30.

While the invention has been shown and described with reference to certain embodiments thereof, it will be understood by those skilled in the art that various changes in form and details may be made therein without departing from the spirit and scope of the invention as defined by the appended claims.

What is claimed is:

1. A cyclone dust collecting apparatus for a wet vacuum cleaner, comprising:
a cyclone body separating air from drawn in contaminants and water;
a contaminant receptacle formed at a bottom portion of the cyclone body to collect contaminants and water separated by the cyclone body; and
a water tank integrally formed with the contaminant receptacle to store clean water.

2. The cyclone dust collecting apparatus according to claim 1, wherein a collectable capacity of contaminants and water in the contaminant receptacle is greater than a storable capacity of water in the water tank.

3. The cyclone dust collecting apparatus according to claim 1, wherein the water tank is formed at a bottom portion of the contaminant receptacle.

4. The cyclone dust collecting apparatus according to claim 3, wherein the contaminant receptacle has a cavity protruding from a bottom surface of the contaminant receptacle, the cavity being fluidly communicated with the water tank.

5. The cyclone dust collecting apparatus according to claim 4, wherein the water tank comprises:
a water tank cover attached to the bottom portion of the contaminant receptacle; and
a water supply valve attached to the water tank cover, the water supply valve being used to selectively discharge water stored between the water tank cover and the bottom surface of the contaminant receptacle.

6. The cyclone dust collecting apparatus according to claim 5, wherein the water tank cover is attached to the bottom portion of the contaminant receptacle by ultrasonic welding.

7. The cyclone dust collecting apparatus according to claim 1, further comprising a contaminant cover attached to a top portion of the contaminant receptacle, the contaminant cover including a contaminant opening to allow the contaminants and water separated by the cyclone body to fall into the contaminant receptacle.

8. The cyclone dust collecting apparatus according to claim 7, wherein the contaminant cover is attached to the top portion of the contaminant receptacle by ultrasonic welding.

9. The cyclone dust collecting apparatus according to claim 7, wherein the contaminant opening is positioned near a circumference of a bottom surface of the contaminant cover in a band form to have such a length that an angle between opposite ends of the contaminant opening and a center of the contaminant cover is approximately 160 degrees to approximately 180 degrees.

10. The cyclone dust collecting apparatus according to claim 7, wherein the contaminant opening has a width of approximately 6 mm to approximately 8 mm.

11. The cyclone dust collecting apparatus according to claim 7, wherein the contaminant cover further comprises a plurality of protrusions formed on the bottom surface of the contaminant cover.

12. The cyclone dust collecting apparatus according to claim 1, further comprising a contaminant discharge path formed at one side of the contaminant receptacle to discharge the contaminants and water from the contaminant receptacle.

13. A cyclone dust collecting apparatus for a wet vacuum cleaner, comprising:
a cyclone body separating air from drawn in contaminants and water; the cyclone body including an air discharge opening for discharging separated air;
a water block member enclosing the air discharge opening to block a discharge of the drawn in water with air and including a cut part at a bottom portion of the water block member; and
a contaminant receptacle formed at a bottom portion of the cyclone body to collect contaminants and water separated by the cyclone body.

14. The cyclone dust collecting apparatus according to claim 13, wherein the cut part has a length such that an angle between opposite ends of the cut part and a center of the water block member is approximately 80 degrees to approximately 90 degrees.

15. The cyclone dust collecting apparatus according to claim 13, wherein the water block member further comprises an inner curtain formed in a bottom end of the water block member and in parallel with the cyclone body.

16. The cyclone dust collecting apparatus according to claim 13, further comprising a water tank to store clean water, the water tank being integrally formed with the contaminant receptacle .

17. The cyclone dust collecting apparatus according to claim 16, wherein a collectable capacity of contaminants and water in the contaminant receptacle is greater than a storable capacity of water in the water tank.
